(19) United States
(12) Patent Application Publication
(10) Pub. No.: US 2022/0050963 A1
(43) Pub. Date: Feb. 17, 2022

(54) FIELD MANAGEMENT CONTINUOUS LEARNING SYSTEM AND METHOD

(71) Applicant: JPMorgan Chase Bank, N.A., New York, NY (US)

(72) Inventors: Taylor D SHIPMAN, Westerville, OH (US); Rodrigo de Siqueira FERNANDES, Montclair, NJ (US); Burton ANDREWS, Dublin, OH (US); Johnathan Luke PETERSON, Hoboken, NJ (US); Benjamin VINZANT, Larchmont, NY (US); Mark BIRKHEAD, New York, NY (US); Nathan COFFEE, Columbus, OH (US); Wentao ZHA, Worthington, OH (US); Sophia DADAS, New Rochelle, NY (US); Evan TURNER, New York, NY (US); Guangyu WANG, New York, NY (US); Chak Kei Jack WONG, Hong Kong (HK)

(73) Assignee: JPMorgan Chase Bank, N.A., New York, NY (US)

(21) Appl. No.: 17/444,868

(22) Filed: Aug. 11, 2021

Related U.S. Application Data
(60) Provisional application No. 63/066,591, filed on Aug. 17, 2020.

(51) Int. Cl. G06F 40/205; G06N 5/02; G06N 5/04; G06F 3/0484

(52) U.S. Cl. CPC G06F 40/205; G06F 3/0484; G06N 5/04; G06N 5/022

(57) ABSTRACT

Various methods, apparatuses/systems, and media for data management are disclosed. A processor integrates internal data, third party data, user-generated content data, and historical data into key data that relates to management of one or more stores and branches in a network of stores and branches. The key data is stored into a single centralized database. The processor generates analytical insights data from analysis of the key data and historical data. The analytical insights data is displayed onto a graphical user interface (GUI) for considering and analyzing the analytical insights data by a user. User's feedback data is received that corresponds to the user's response based on analyzing the analytical insights data. The processor apples machine learning (ML) algorithms for continuously analyzing all available data including the user's feedback data and extracting and classifying contents of available data including the feedback data to provide targeted recommendations data onto the GUI.

### CROSS-REFERENCE TO RELATED APPLICATIONS

This application claims the benefit of priority from U.S. Provisional Patent Application No. 63/066,591, filed Aug. 17, 2020, which is herein incorporated by reference in its entirety.

### TECHNICAL FIELD

This disclosure generally relates to data processing, and, more particularly, to methods and apparatuses for implementing a digital (e.g., web-based) planning module (e.g., user interface) for managing strategies and tactics of every store or branch in a network of stores or branches, along with a back end system that continuously learns from the data fed into the system.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

In general, large enterprises, corporations, agencies, institutions, and other organizations are facing a continuing problem of handling, processing, and/or accurately describing a vast amount of data that are crucial to plan actions at store level or market/regional level in an efficient and expedited manner. The stored data is often not in a centralized location, yet needs to be analyzed by a variety of persons within the organization to inform strategy, which may prove to be extremely time consuming, confusing, inaccurate, and inefficient for planning actions at both store level and market/regional level.

For example, currently, management of stores and markets/regions (groups of stores within a geographic area) is conducted with limited data, or with many disparate data sources that are not centralized. There appears to be no mechanism to identify the best management actions that result in the best outcome, nor to prioritize the different things on which a store should focus. For example, today's management system lacks the capability to provide prioritization of actions that a store could take that would yield the most value to the customer or to the business. Furthermore, there appears to be no systematic way to transfer the learnings from one store or market/region to a similar store or market/region that would benefit from this information or learned strategy. Moreover, managers that move on take their information with them; and conventional management system lacks the capability to permanently capture and store the learnings about a store or market/region—what worked and what did not. Furthermore, conventional management systems lack the capabilities of providing customized or personalized insight, recommendations, and actions for the unique needs of every store.

### SUMMARY

The present disclosure, through one or more of its various aspects, embodiments, and/or specific features or sub-components, may provide, among others, various systems, servers, devices, methods, media, programs, and platforms for implementing a data management module for managing strategies and tactics of every store or branch in a network of stores or branches, along with a back end system that continuously learns from the data fed into the system, but the disclosure is not limited thereto. For example, the present disclosure, through one or more of its various aspects, embodiments, and/or specific features or sub-components, may also provide, among others, various systems, servers, devices, methods, media, programs, and platforms for implementing a data management module that may be configured to provide intelligent recommendations to branches for actionable insights that are: thoroughly data-driven and rigorously tested; true to the branch's context; highlight the highest opportunity; available at the branch level and for groups of branches, etc.

According to an aspect of the present disclosure, a method for data management by utilizing one or more processors and one or more memories is disclosed. The method may include: accessing a plurality of data sources that include internal data, third party data, user-generated content data, and historical data; integrating the internal data, third party data, user-generated content data, and the historical data into key data that relates to management of one or more stores and branches in the network of stores and branches; storing the key data into a single centralized database; generating analytical insights data from analysis of the key data and historical data; displaying the analytical insights data onto a graphical user interface (GUI) for considering and analyzing the analytical insights data by a user; receiving user's feedback data that corresponds to the user's response based on analyzing the analytical insights data; and applying machine learning (ML) algorithms for continuously analyzing all available data including the user's feedback data and extracting and classifying contents of all available data including the feedback data to provide targeted recommendations data onto the GUI.

According to an additional aspect of the present disclosure, data management module implements an inference framework/method (i.e., a casual inference framework/method) powered by double machine learning algorithms, developed as a pipeline and collection of reusable packages for reuse across multiple models and for other projects, to analyze performance, contextual, and user input data to distil actionable insights that reflect to each branch's unique situation. Thus, by implementing the double machine learning algorithms, the data management module may be configured to capture and quantify the marginal effects of the actual causes of a phenomenon. However, the disclosure is not limited to the double machine learning algorithms. The casual inference framework/method may also include one or more of the following: orthogonal random forests, doubly robust learning, meta-algorithms, deep instrumental variables, etc.

According to a further aspect of the present disclosure, internal data, third party data, user-generated content data, and historical data are not limited to data relating to one or more stores or branches in a network of stores and branches. For example, the internal data, third party data, user-generated content data, and historical data may also relate to data beyond the store or branch itself. For example, the internal data, third party data, user-generated content data, and historical data may also relate to data related to customers of a store or branch; or data related to prospective customers of a store or branch; or data related to nearby competitive stores or branch; or data related to macro-economic trends in the area, etc., but the disclosure is not limited thereto. Thus, throughout the disclosure, data relating to one or more stores or branches should encompass not only data relating to one or more stores or branches in a network of stores and branches, but also to data related to customers of a store or branch; or data related to prospective customers of a store or branch; or data related to nearby competitive stores or branch; or data related to macro-economic trends in the area, etc., but the disclosure is not limited thereto.

According to another aspect of the present disclosure, the method may further include: generating structured and standardized dataset from the key data for analysis, wherein the structured and standardized dataset includes attributes derived from user input data including topic natural language processing.

According to yet another aspect of the present disclosure, wherein the feedback data is generated from the user's responses to pre-set questions, including selecting from pre-defined options and free-form text.

According to further aspect of the present disclosure, wherein the targeted recommendations data includes customized recommendations data for every store or branch within the network of stores and branches, and personalized data based on full store-level or branch-level contextual data and segmentation.

According to yet another aspect of the present disclosure, the method may further include: prioritizing actions data from the targeted recommendations data that would yield the most value to an organization's predefined business goals.

According to an additional aspect of the present disclosure, the method may further include: implementing text mining, natural language processing, and other ML techniques based on text input from the user.

According to yet another aspect of the present disclosure, the method may further include: extracting data related to key themes and topics by store or branch segment, division, and market.

According to another aspect of the present disclosure, the method may further include: receiving additional feedback data via the GUI that corresponds to the user's response based on analyzing the targeted recommendations data.

According to an additional aspect of the present disclosure, a system for data management is disclosed. The system may include a plurality of data sources that include internal data, third party data, user-generated content data, and historical data; and a processor coupled to the plurality of data sources via a communication network. The processor may be configured to: integrate the internal data, third party data, user-generated content data, and the historical data into key data by accessing the plurality of data sources; store the key data into a single centralized database; generate analytical insights data from analysis of the key data and historical data; display the analytical insights data onto a graphical user interface (GUI) for considering and analyzing the analytical insights data by a user; receive user's feedback data that corresponds to the user's response based on analyzing the analytical insights data; and apply machine learning (ML) algorithms for continuously analyzing all available data including the user's feedback data and extracting and classifying contents of all available data including the feedback data to provide targeted recommendations data onto the GUI.

According to another aspect of the present disclosure, the processor may be further configured to generate structured and standardized dataset from the key data for analysis, wherein the structured and standardized dataset includes attributes derived from user input data including topic natural language processing.

According to yet another aspect of the present disclosure, wherein the processor may generate the feedback data from the user's responses to pre-set questions, including selecting from pre-defined options and free-form text.

According to a further aspect of the present disclosure, the processor may be further configured to prioritize actions data from the targeted recommendations data that would yield the most value to an organization's predefined business goals.

According to an additional aspect of the present disclosure, the processor may be further configured to implement text mining, natural language processing, and other ML techniques based on text input from the user.

According to yet another aspect of the present disclosure, the processor may be further configured to extract data related to key themes and topics by store or branch segment, division, and market.

According to another aspect of the present disclosure, the processor may be further configured to receive additional feedback data via the GUI that corresponds to the user's response based on analyzing the targeted recommendations data.

According to another aspect of the present disclosure, a non-transitory computer readable medium configured to store instructions for data management is disclosed. The instructions, when executed, may cause a processor to perform the following: accessing a plurality of data sources that include internal data, third party data, user-generated content data, and historical data; integrating the internal data, third party data, user-generated content data, and the historical data into key data that relates to management of one or more stores and branches in the network of stores and branches; storing the key data into a single centralized database; generating analytical insights data from analysis of the key data and historical data; displaying the analytical insights data onto a graphical user interface (GUI) for considering and analyzing the analytical insights data by a user; receiving user's feedback data that corresponds to the user's response based on analyzing the analytical insights data; and applying machine learning (ML) algorithms for continuously analyzing all available data including the user's feedback data and extracting and classifying contents of all available data including the feedback data to provide targeted recommendations data onto the GUI.

According to another aspect of the present disclosure, the instructions, when executed, may cause the processor to generate structured and standardized dataset from the key data for analysis, wherein the structured and standardized dataset includes attributes derived from user input data including topic natural language processing.

According to yet another aspect of the present disclosure, the instructions, when executed, may cause the processor to generate the feedback data from the user's responses to pre-set questions, including selecting from pre-defined options and free-form text.

According to a further aspect of the present disclosure, the instructions, when executed, may cause the processor to prioritize actions data from the targeted recommendations data that would yield the most value to an organization's predefined business goals.

According to an additional aspect of the present disclosure, the instructions, when executed, may cause the processor to implement text mining, natural language processing, and other ML techniques based on text input from the user.

According to yet another aspect of the present disclosure, the instructions, when executed, may cause the processor to extract data related to key themes and topics by store or branch segment, division, and market.

According to another aspect of the present disclosure, the instructions, when executed, may cause the processor to receive additional feedback data via the GUI that corresponds to the user's response based on analyzing the targeted recommendations data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a data management device in accordance with an exemplary embodiment.

FIG. 2 illustrates an exemplary diagram of a network environment with a data management device in accordance with an exemplary embodiment.

FIG. 3 illustrates a system diagram for implementing a data management device with a data management module in accordance with an exemplary embodiment.

FIG. 4 illustrates a system diagram for implementing a data management module of FIG. 3 in accordance with an exemplary embodiment.

FIG. 5 illustrates a process in data management in accordance with an exemplary embodiment.

FIG. 6A illustrates an exemplary graphical user interface displaying market overview data in accordance with an exemplary embodiment.

FIG. 6B illustrates an exemplary graphical user interface displaying market heatmap data in accordance with an exemplary embodiment.

FIG. 6C illustrates an exemplary graphical user interface displaying branch overview data in accordance with an exemplary embodiment.

FIG. 6D illustrates an exemplary graphical user interface displaying branch deep dive data in accordance with an exemplary embodiment.

FIG. 7 illustrates a flow chart for data management in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units, devices, engines, and/or modules. Those skilled in the art will appreciate that these blocks, units, devices, engines, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, devices, engines, and/or modules being implemented by microprocessors or similar, they may be programmed using software (e.g., microcode) to perform various functions discussed herein and may optionally be driven by firmware and/or software. Alternatively, each block, unit, device, engines, and/or module may be implemented by dedicated hardware, or as a combination of dedicated hardware to perform some functions and a processor (e.g., one or more programmed microprocessors and associated circuitry) to perform other functions. Also, each block, unit, device, engine, and/or module of the example embodiments may be physically separated into two or more interacting and discrete blocks, units, devices, engines, and/or modules without departing from the scope of the inventive concepts. Further, the blocks, units, devices, engines, and/or modules of the example embodiments may be physically combined into more complex blocks, units, devices, engines, and/or modules without departing from the scope of the present disclosure.

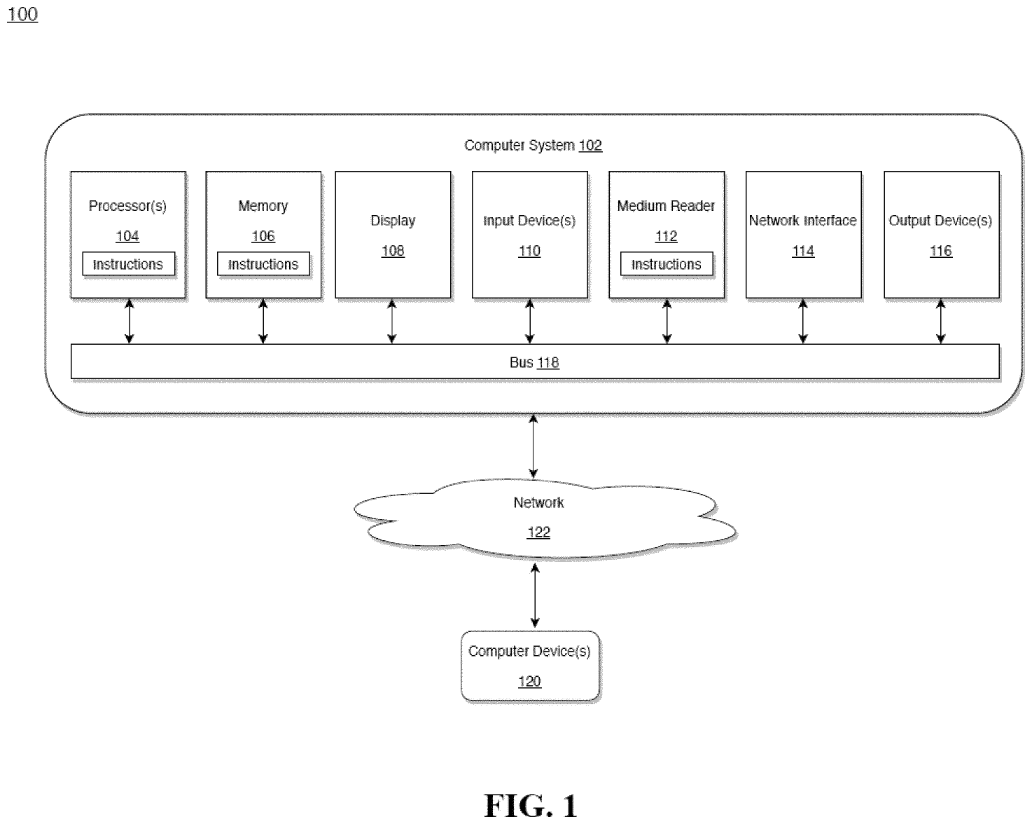

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized processes for implementing a data management module for managing strategies and tactics of every store or branch in a network of stores or branches, along with a back end system that continuously learns from the data fed into the system, but the disclosure is not limited thereto.

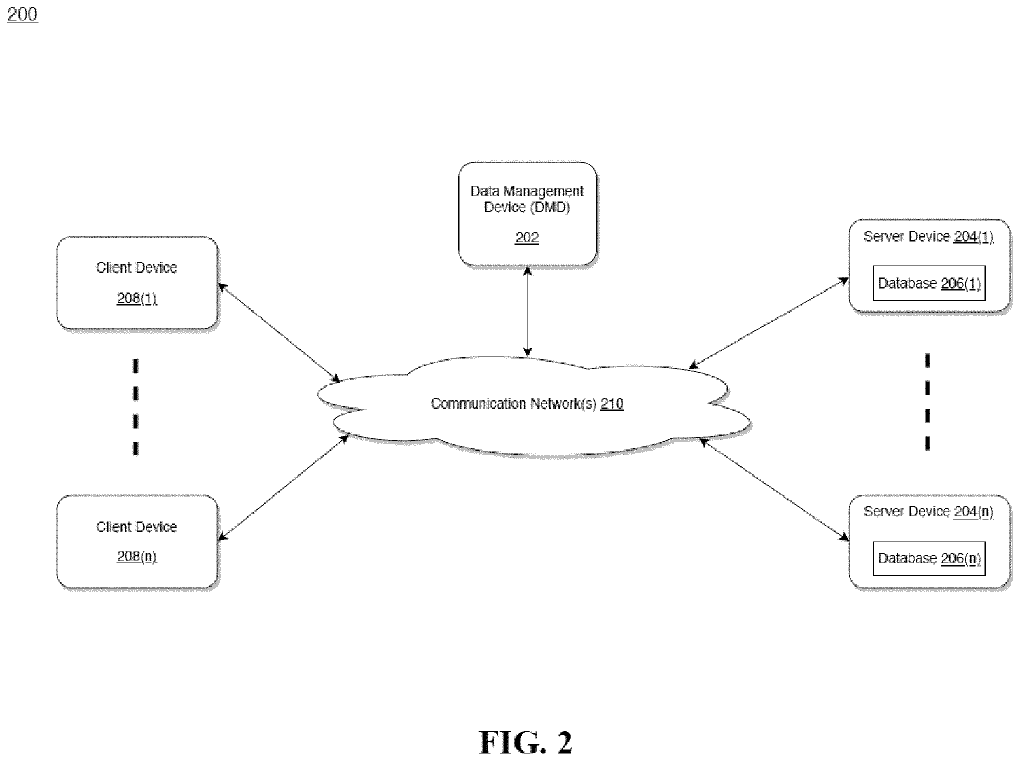

Referring to FIG. 2, a schematic of an exemplary network environment 200 for implementing a data management device (DMD) of the instant disclosure is illustrated.

According to exemplary embodiments, the above-described problems associated with conventional system may be overcome by implementing an DMD 202 having data management module (e.g., a web-based planning user interface) as illustrated in FIG. 2 for managing strategies and tactics of every store or branch in a network of stores or branches, along with a back end system that continuously learns from the data fed into the system, but the disclosure is not limited thereto.

The DMD 202 may be the same or similar to the computer system 102 as described with respect to FIG. 1.

The DMD 202 may store one or more applications that can include executable instructions that, when executed by the DMD 202, cause the DMD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DMD 202 itself, may be located in virtual server(s) running in a cloud-based computing environment rather than being tied to one or more specific physical network computing devices. Also, the application(s) may be running in one or more virtual machines (VMs) executing on the DMD 202. Additionally, in one or more embodiments of this technology, virtual machine(s) running on the DMD 202 may be managed or supervised by a hypervisor.

In the network environment 200 of FIG. 2, the DMD 202 is coupled to a plurality of server devices 204(1)-204(n) that hosts a plurality of databases 206(1)-206(n), and also to a plurality of client devices 208(1)-208(n) via communication network(s) 210. A communication interface of the DMD 202, such as the network interface 114 of the computer system 102 of FIG. 1, operatively couples and communicates between the DMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DMD 202 may be a standalone device or integrated with one or more other devices or apparatuses, such as one or more of the server devices 204(1)-204(n), for example. In one particular example, the DMD 202 may be hosted by one of the server devices 204(1)-204(n), and other arrangements are also possible. Moreover, one or more of the devices of the DMD 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DMD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the DMD 202 that may be configured for managing strategies and tactics of every store or branch in a network of stores or branches, along with a back end system that continuously learns from the data fed into the system, but the disclosure is not limited thereto.

Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the DMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the DMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DMD 202, the server devices 204(1)-204(n), or the client devices 208(1)-208(n), for example, may be configured to operate as virtual instances on the same physical machine. For example, one or more of the DMD 202, the server devices 204(1)-204(n), or the client devices 208(1)-208(n) may operate on the same physical device rather than as separate devices communicating through communication network(s) 210. Additionally, there may be more or fewer DMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

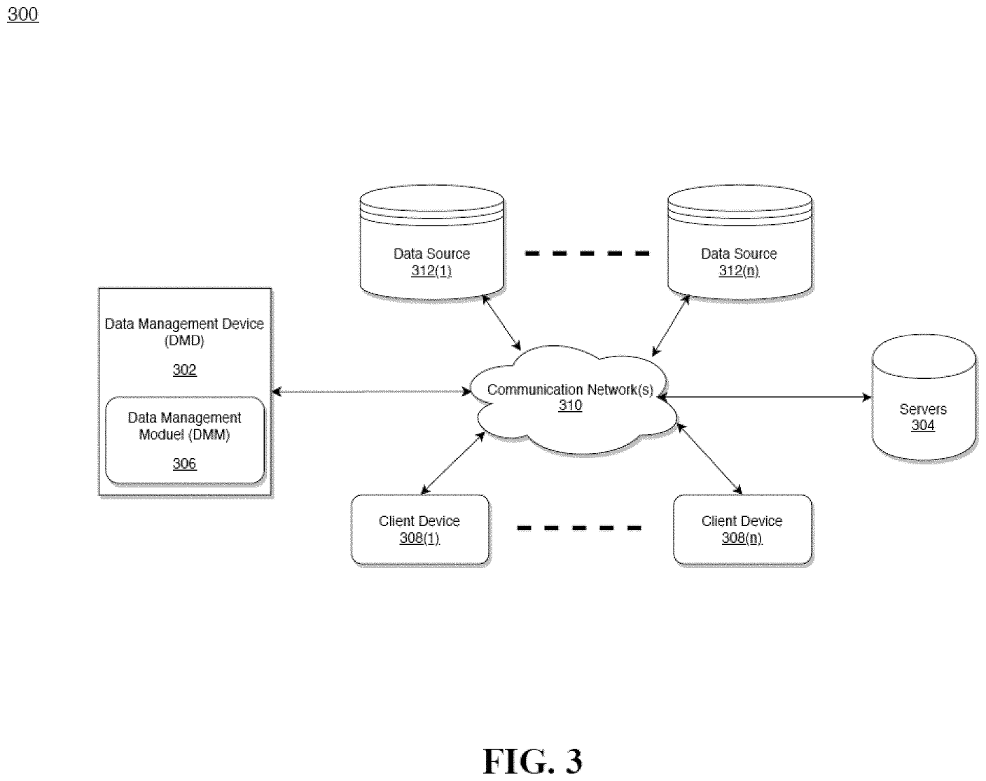

FIG. 3 illustrates a system diagram for implementing a DMD with a data management module (DMM) in accordance with an exemplary embodiment.

As illustrated in FIG. 3, in the system 300, according to exemplary embodiments, the DMD 302 including the DMM 306 may be connected to a plurality of servers 304, a plurality of data sources 312(1)-312(n), and a plurality of client devices 308(1)-308(n) via a communication network 310, but the disclosure is not limited thereto. For example, according to exemplary embodiments, the DMM 306 may be connected to any desired database besides data sources 312(1)-312(n). According to exemplary embodiments, the plurality of data sources 312(1)-312(n) may be configured to store internal data, third party data, user-generated content data, and historical data relating to one or more stores and branches in a network of stores and branches, but the disclosure is not limited thereto. For example, the plurality of data sources 312(1)-312(n) may provide internal data, third party data, user-generated content data, and historical data relating to one or more stores and branches in a network of stores and branches customers of a store or branch; or data related to prospective customers of a store or branch; or data related to nearby competitive stores or branch; or data related to macro-economic trends in the area, etc., but the disclosure is not limited thereto.

As it will be discussed in further details below, according to exemplary embodiments, the plurality of data sources 312(1)-312(n) may include internal data, external (third party) data, and data input from the users of the digital tool. The tool front end would feature curated analytical insights from analysis of historical data, presented to the manager for consideration. The front end would feature the ability for the user to enter responses to set questions, including selecting from pre-defined options and free-form text. The system would capture the user input and store the raw input in a database (e.g., a single database different from the plurality of data sources 312(1)-312(n)), alongside the other data sourced internally and externally from these data sources 312(1)-312(n).

As it will be further discussed in further details below, according to exemplary embodiments, a machine learning layer may analyze the user input, extract and classifies the content, and store the output from the machine learning layer in the database alongside the other data as enriched user input. Techniques for this layer may include text mining, natural language processing, and other ML techniques. A secondary layer may analyze all the variables produced from all internal data, external data, and enriched user input, and enables recommendations to be developed both by humans and machines in this layer. Both are fed into a third layer that prioritizes the actions to be taken at each branch or store in the network.

According to exemplary embodiments, the implementation of a DMD with a data management module (DMM) may provide data management architectures and the integration and reporting on metadata within an organization, including the organization's domains (e.g., lines of business, departments, technologies, etc.). For example, the inventory of glossary may be configured to receive data (e.g., logical business terms) from corresponding lines of business computing units. According to exemplary embodiments, the DMD 302 may also receive data from external glossaries. In one exemplary embodiment, graph databases and semantic search technologies may be used to enable the incorporation of a wide array of data sources as well as flexible, intuitive user interfaces.

According to exemplary embodiments, the DMM 306 within the DMD 302 may be configured to access the plurality of data sources 312(1)-312(n) that contains internal data, third party data, user-generated content data, and historical data relating to one or more stores and branches in a network of stores and branches, but the disclosure is not limited thereto.

For example, according to exemplary embodiments, the DMM 306 may be configured to integrate the internal data, third party data, user-generated content data, and the historical data into key data that relates to management of the one or more stores and branches in the network of stores and branches by accessing the plurality of data sources 312(1)-312(n); store the key data into a single centralized database; generate analytical insights data from analysis of the key data and historical data; display the analytical insights data onto a graphical user interface (GUI) for considering and analyzing the analytical insights data by a user; receive user's feedback data that corresponds to the user's response based on analyzing the analytical insights data; and apply machine learning (ML) algorithms for continuously analyzing all available data including the user's feedback data and extracting and classifying contents of all available data including the feedback data to provide targeted recommendations data onto the GUI, but the disclosure is not limited thereto.

According to exemplary embodiment, the DMD 302 is described and shown in FIG. 3 as including the DMM 306, although it may include other rules, policies, modules, data sources, or applications, for example.

According to exemplary embodiments, the server 304 may be the same or equivalent to the server device 204 as illustrated in FIG. 2.

The process may be executed via the communication network 310, which may comprise plural networks as described above. For example, in an exemplary embodiment, the plurality of data sources 312(1)-312(n), servers 304 and the client devices 308(1)-308(n) may communicate with the DMD 302 via broadband or cellular communication. Of course, these embodiments are merely exemplary and are not limiting or exhaustive.

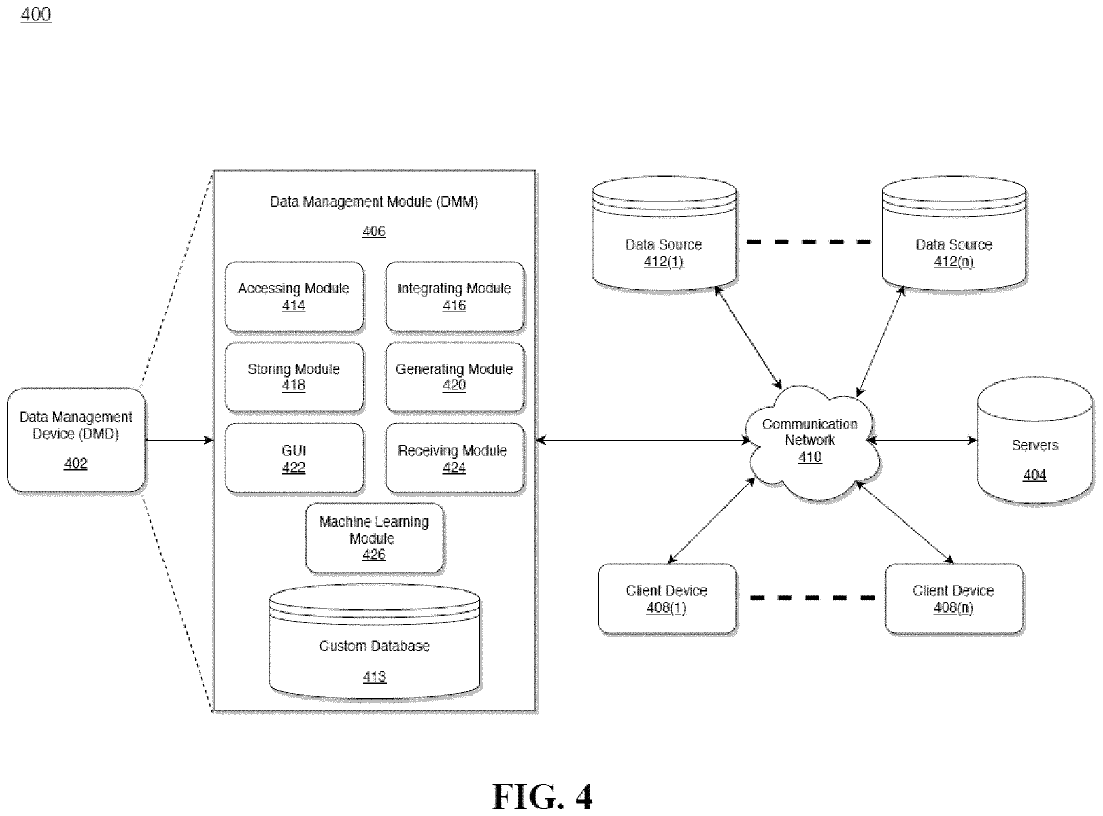

FIG. 4 illustrates a system diagram for implementing a data management module of FIG. 3 in accordance with an exemplary embodiment. As illustrated in FIG. 4, the system 400 may include a DMD 402 within which a DMM 406 may be embedded, a plurality of data sources 412(1)-412(n), servers 404, and a communication network 410.

As illustrated in FIG. 4, the DMM 406 may include an accessing module 414, an integrating module 416, a storing module 418, a generating module 420, a GUI 422, a receiving module 424, a machine learning module 426, and a custom database 413. According to exemplary embodiments, the plurality of data sources 412(1)-412(n) may be external and/or to the DMD 402 and the DMD 402 may include various systems that are managed and operated by an organization. The plurality of data sources 412(1)-412(n) may be the same or similar to the plurality of data sources 312(1)-312(n) may be as illustrated in FIG. 3. Thus, the plurality of data sources 412(1)-412(n) may also contain internal data, third party data, user-generated content data, and historical data relating to one or more stores and branches in a network of stores and branches, but the disclosure is not limited thereto. For example, the plurality of data sources 412(1)-412(n) may contain internal data, third party data, user-generated content data, and historical data related to one or more stores and branches in a network of stores and branches; or data related to prospective customers of a store or branch; or data related to nearby competitive stores or branch; or data related to macro-economic trends in the area, etc., but the disclosure is not limited thereto.

The process may be executed via the communication network 410, which may comprise plural networks as described above. For example, in an exemplary embodiment, the various components of the DMM 406 may communicate with the servers 404, the client devices 408(1)-408(n), and the plurality of data sources 412(1)-412(n) via the communication network 410. Of course, these embodiments are merely exemplary and are not limiting or exhaustive.

According to exemplary embodiments, the communication network 410 may be configured to establish a link between the DMM 406 and the plurality of data sources 412(1)-412(n), servers 404, and the client devices 408(1)-408(n).

According to exemplary embodiments, each of the accessing module 414, integrating module 416, storing module 418, generating module 420, receiving module 424, and the machine learning module 426 may be implemented by microprocessors or similar, they may be programmed using software (e.g., microcode) to perform various functions discussed herein. Alternatively, each of the accessing module 414, integrating module 416, storing module 418, generating module 420, receiving module 424, and the machine learning module 426 may be implemented by dedicated hardware, or as a combination of dedicated hardware to perform some functions and a processor (e.g., one or more programmed microprocessors and associated circuitry) to perform various functions discussed herein as well as other functions. Also, according to exemplary embodiments, each of the accessing module 414, integrating module 416, storing module 418, generating module 420, receiving module 424, and the machine learning module 426 may be physically separated into two or more interacting and discrete blocks, units, devices, and/or modules without departing from the scope of the inventive concepts.

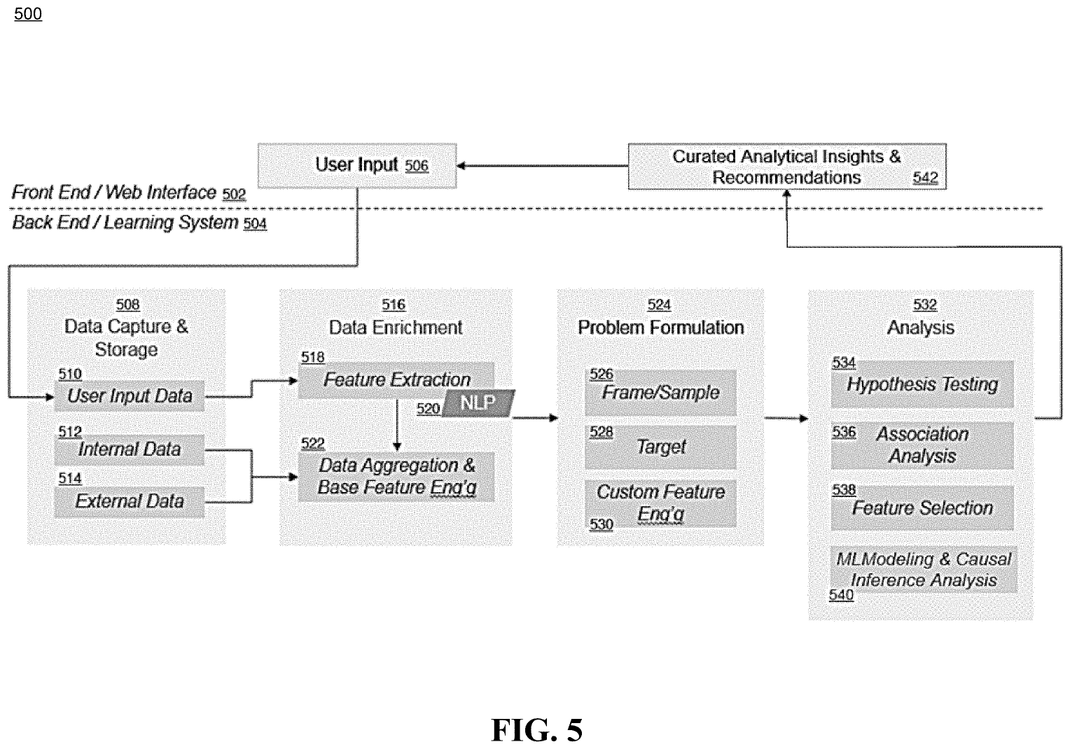

FIG. 5 illustrates a process diagram 500 in data management in accordance with an exemplary embodiment. It will be appreciated that the illustrated process 500 and associated steps may be performed in a different order, with illustrated steps omitted, with additional steps added, or with a combination of reordered, combined, omitted, or additional steps.

As illustrated in FIG. 5, the exemplary process diagram 500 includes a front end/web interface 502 portion and a back end/learning system 504 portion. User input 506 and curated analytical insights and recommendations 542 of the process diagram 500 may be performed within the front end/web interface 502 portion of the process. According to exemplary embodiments, data capture and storage 508, data enrichment 516, problem formulation 524, and analysis 532 of the process diagram 500 may be performed within the back end/learning system 504 portion of the process.

According to exemplary embodiments, the process of data capture and storage 508 may include receiving user input data 510, internal data 512, and external data 514. The process of data enrichment 516 may include a feature extraction process 518 and data aggregation and base feature engineering process 522. The feature extraction process 518 may receive the user input data 510 and the base feature engineering process 522 may receive the internal data 512 and the external data 514 to perform data enrichment. According to exemplary embodiments, the feature extraction process 518 may include natural language processing (NLP) 520 to perform data enrichment. Output from data enrichment 516 may be inputted for problem formulation 524 which may include frame/sample 526, target 528, and custom feature engineering 530. Output from problem formulation 524 may be inputted for analysis 532 which may include hypothesis testing 534, association analysis 536, feature selection 538, and machine learning modeling and casual inference analysis 540. Output from analysis 532 may be inputted to curated analytical insights and recommendations 542.

For example, referring to FIGS. 4 and 5, according to exemplary embodiments, the accessing module 414 may be configured to access the plurality of data sources 412(1)-412(n) that include internal data 512, external data 514 (e.g., third party data), user input data 510 (e.g., user-generated content data), and historical data relating to one or more stores and branches in a network of stores and branches; or data relating to prospective customers of a store or branch; or data relating to nearby competitive stores or branch; or data relating to macro-economic trends in the area, etc., but the disclosure is not limited thereto.

According to exemplary embodiments, the integrating module 416 may be configured to integrate internal data 512, external data 514 (e.g., third party data), user input data 510 (e.g., user-generated content data), and historical data into key data that relates to management of the one or more stores and branches in the network of stores and branches.

According to exemplary embodiments, the storing module 418 may be configured to store the key data into the custom database (e.g., a single centralized database). The generating module 420 may be configured to generate analytical insights data (e.g., curated analytical insights and recommendations 542) from analysis 532 of the key data and historical data. The analytical insights data (e.g., curated analytical insights and recommendations 542) may be displayed onto the GUI 422 for considering and analyzing the analytical insights data by a user. The receiving module 424 may be configured to receive user's feedback data (e.g., user input 506) that corresponds to the user's response based on analyzing the analytical insights data and recommendations data.

According to exemplary embodiments, the machine learning module 426 may be configured to apply machine learning (ML) algorithms for continuously analyzing all available data as mentioned above including the user's feedback data and extracting and classifying contents of all available data including the feedback data to provide targeted recommendations data onto the GUI 422.

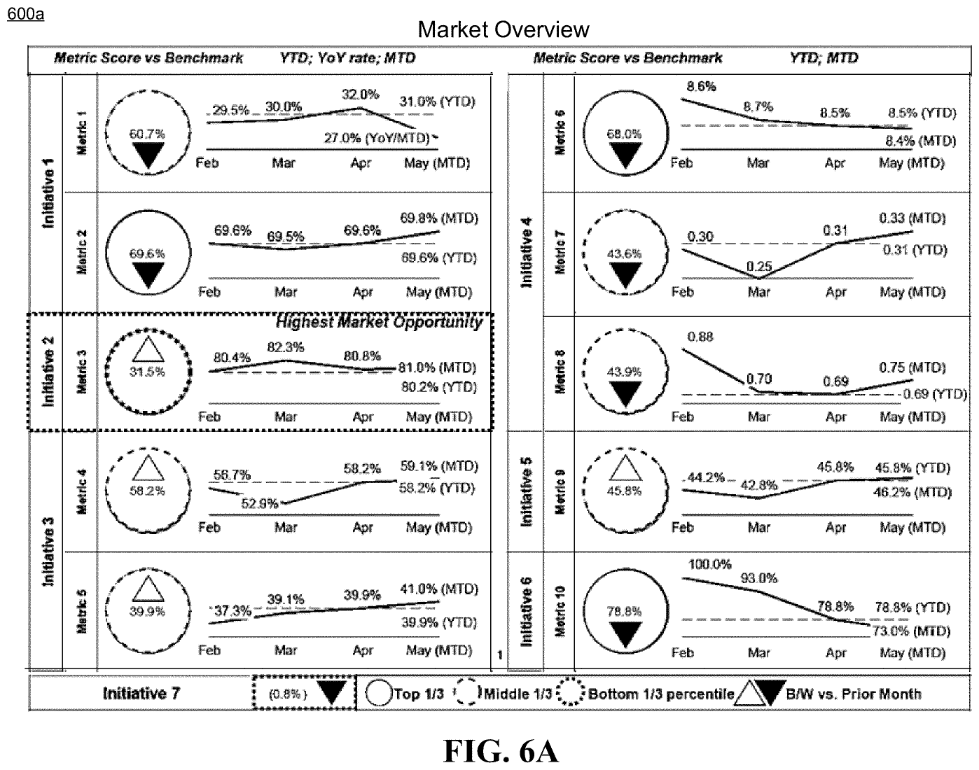

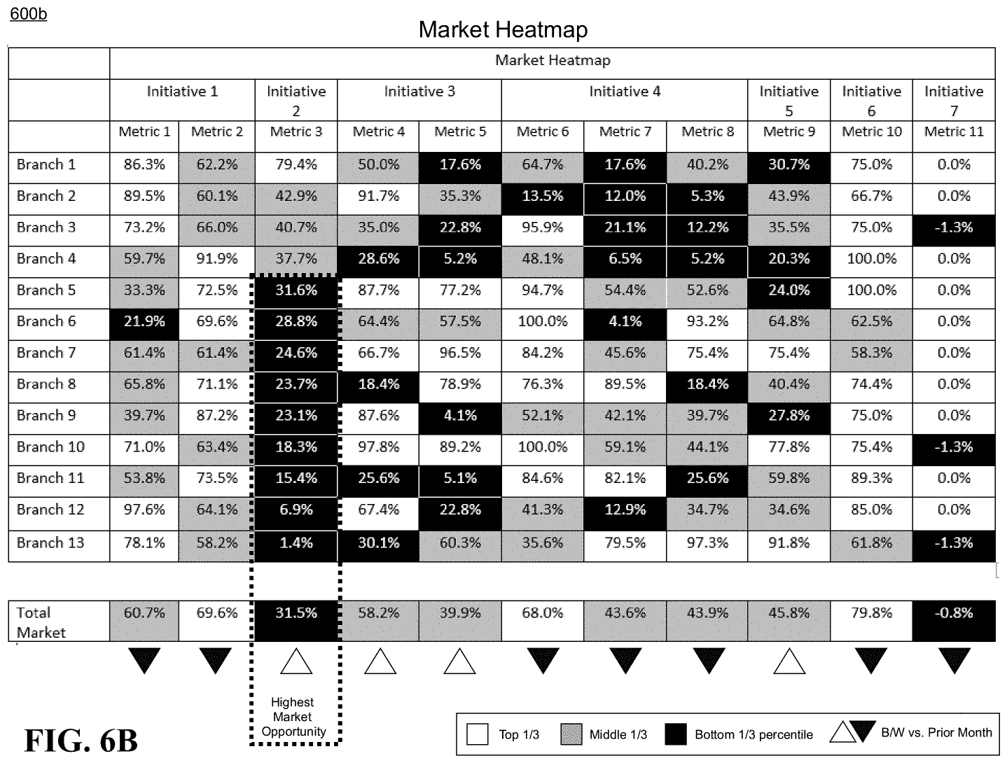

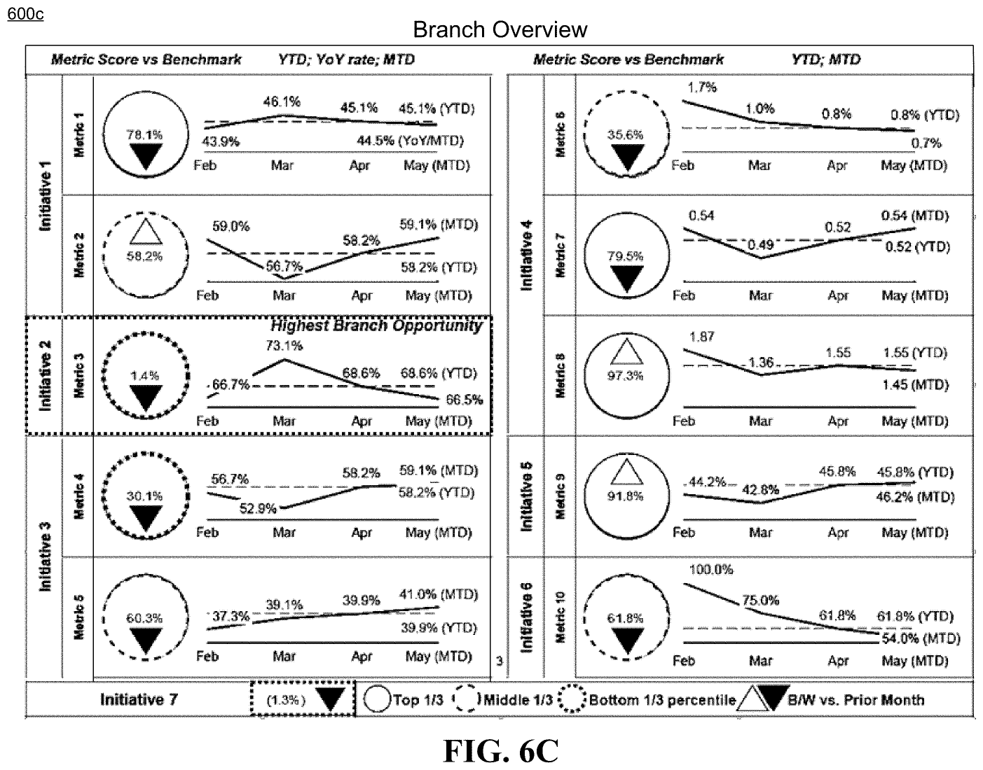

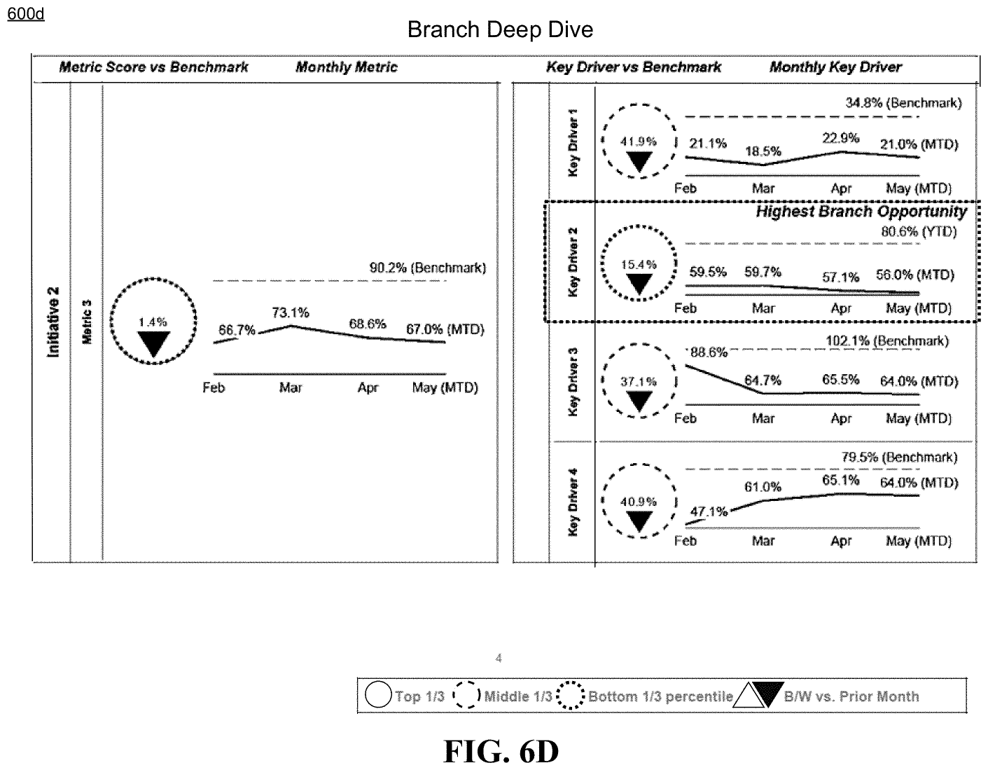

For example, FIG. 6A illustrates an exemplary graphical user interface 600a in accordance with an exemplary embodiment which displays a window that illustrates market overview data, but the disclosure is not limited thereto. FIG. 6B illustrates an exemplary graphical user interface 600b in accordance with an exemplary embodiment which displays a window that illustrates market heatmap data, but the disclosure is not limited thereto. FIG. 6C illustrates an exemplary graphical user interface 600c in accordance with an exemplary embodiment which displays a window that illustrates branch overview data, but the disclosure is not limited thereto. FIG. 6D illustrates an exemplary graphical user interface 600d in accordance with an exemplary embodiment which displays a window that illustrates branch deep dive data, but the disclosure is not limited thereto.

According to exemplary embodiments, the generating module 420 may be further configured to generate structured and standardized dataset from the key data for analysis 532. According to exemplary embodiments, the structured and standardized dataset may include attributes derived from user input data including topic natural language processing, but the disclosure is not limited thereto.

According to exemplary embodiments, the feedback data may be generated from the user's responses to pre-set questions, including selecting from pre-defined options and free-form text, but the disclosure is not limited thereto.

According to exemplary embodiments, the targeted recommendations data may include customized recommendations data for every store or branch within the network of stores and branches, and personalized data based on full store-level or branch-level contextual data and segmentation, but the disclosure is not limited thereto.

According to exemplary embodiments, the DMM 406 may be further configured to prioritize actions data from the targeted recommendations data that would yield the most value to an organization's predefined business goals (e.g., vetting and prioritization).

According to exemplary embodiments, the DMM 406 may be further configured to implement text mining, natural language processing (e.g., NLP 520 as illustrate din FIG. 5), and other ML techniques based on text input from the user.

According to exemplary embodiments, the DMM 406 may be further configured to extract data related to key themes and topics by store or branch segment, division, and market.

According to exemplary embodiments, the receiving module 424 may be configured to receive additional feedback data via the GUI 422 that corresponds to the user's response based on analyzing the targeted recommendations data.

According to exemplary embodiments, the DMM 406 may be configured for providing robust systems for data ingestion and transformation. Centralized datasets as generated by the DMM 406 may enable robust feature extraction and engineering systems to be layered on top of raw data sources. Fully documented data lineage, logic, and metadata enables models to be developed from the data with confidence. The custom database 413 allows for central source of data for multiple projects. The disclosed infrastructure provided by the DMM 406 significantly improves speed to insight to data and execution compared to conventional data management systems. Thus, the data infrastructure achieved by the DMM 406 can execute customized, dynamic and interactive strategies and plans at scale, but the disclosure is not limited thereto.

According to exemplary embodiments, the conceptual infrastructure components of the DMM 406 may be represented as follows: data sources relevant to branch management may be loaded to centralized databases; key branch and market-level attributes may be loaded into a centralized database; critical content from the database may be pushed to the web application, and over time, ML engine may recommend most relevant content, thereby providing the right information to the right branch at the right time; filed management may provide their own content (growth plans, action plans, commentary, forms, ideas, etc.), which may be captured in the database and used to improve ML-based recommendations, building in two-way accountability for truth and relevance. According to exemplary embodiments, the web UI may be an interactive web-based field management tool that may include a branch action plan tool, market growth plan tool, opportunity dashboard, controls management dashboard, etc., but the disclosure is not limited thereto.

According to exemplary embodiments, foundational data aggregation, enrichment, and analysis may lay the groundwork for ML (Machine Learning)/AI (Artificial Intelligence) as pyramidal data structure starting from base to the top as follows: raw data (i.e., internal 512, external 514 (third party), and user input data 510 (user-generated content)) that may be key data centralized into single database (e.g., custom database 413) for consistent, production-grade view; enriched dataset (e.g., structured and standardized for analysis) which may include attributes derived from user input (e.g. topic tagging, sentiment analysis); foundational analysis data (e.g., massive feature engineering and selection) which may include basic feature engineering and statistical selection methods to identify the most impactful action to take to improve a KPI or KRI, given the context; business recommendations data which may include recommendations guided by business rules developed by business SMEs and vetted by rigorous data analysis; AI-driven recommendations data which may include recommendations data guided by AI/ML models trained on historical data and tested for incremental lift over baseline of recommendations developed via simpler means; and real-time conversation and feedback loop between field leadership and analytics system.

According to exemplary embodiments, branch KPIs, and KRIS data may lay out what needs to be improved? e.g., customer satisfaction, customer growth, engagement and attrition, policy adherence, etc. Branch actions data may lay out what are the options for improving? e.g., adherence to branch behaviors, sales practices, controls and compliance guidelines; completion of assigned training and performance management activities, etc. Branch contexts data may lay out what are the characteristics of the branch—location and otherwise—that would make the action more/less relevant? e.g., customer segment and relationship, competitive landscape, etc. In summary, for each KPI/KRI, the DMM 406 may be configured to determine which actions work best given the context of the branch.

FIG. 7 illustrates a flow chart for data management in accordance with an exemplary embodiment.

It will be appreciated that the illustrated process 700 and associated steps may be performed in a different order, with illustrated steps omitted, with additional steps added, or with a combination of reordered, combined, omitted, or additional steps.

As illustrated in FIG. 7, at step S702 of the process 700, a plurality of data sources may be accessed. The plurality of data sources may include internal data, third party data, user-generated content data, and historical data relating to one or more stores and branches in a network of stores and branches; or data relating to prospective customers of a store or branch; or data relating to nearby competitive stores or branch; or data relating to macro-economic trends in the area, etc., but the disclosure is not limited thereto.

According to exemplary embodiments, at step S704 of the process 700, the internal data, third party data, user-generated content data, and the historical data may be integrated into key data that relates to management of the one or more stores and branches in the network of stores and branches.

At step S706 of the process 700, the key data may be stored into a single centralized database.

At step S708 of the process 700, analytical insights data may be generated from analysis of the key data and historical data.

At step S710 of the process 700, the analytical insights data may be displayed onto a graphical user interface (GUI) for considering and analyzing the analytical insights data by a user.

At step S712 of the process 700, user's feedback data may be received that corresponds to the user's response based on analyzing the analytical insights data.

At step S714, of the process 700, machine learning (ML) algorithms may be applied for continuously analyzing all available data including the user's feedback data and extracting and classifying contents of all available data including the feedback data to provide targeted recommendations data onto the GUI.

According to exemplary embodiments, the process 700 may further include: generating structured and standardized dataset from the key data for analysis, wherein the structured and standardized dataset includes attributes derived from user input data including topic natural language processing.

According to exemplary embodiments, the process 700 may further include: prioritizing actions data from the targeted recommendations data that would yield the most value to an organization's predefined business goals.

According to exemplary embodiments, the process 700 may further include: implementing text mining, natural language processing, and other ML techniques based on text input from the user.

According to exemplary embodiments, the process 700 may further include: extracting data related to key themes and topics by store or branch segment, division, and market.

According to exemplary embodiments, the process 700 may further include: receiving additional feedback data via the GUI that corresponds to the user's response based on analyzing the targeted recommendations data.

According to exemplary embodiments, a non-transitory computer readable medium may be configured to store instructions for data management is disclosed. According to exemplary embodiments, the instructions, when executed, may cause a processor embedded within the DMM 406 or the DMD 402 to perform the following: accessing a plurality of data sources that include internal data, third party data, user-generated content data, and historical data relating to one or more stores and branches in a network of stores and branches; integrating the internal data, third party data, user-generated content data, and the historical data into key data that relates to management of the one or more stores and branches in the network of stores and branches; or data relating to prospective customers of a store or branch; or data relating to nearby competitive stores or branch; or data relating to macro-economic trends in the area, etc., but the disclosure is not limited thereto; storing the key data into a single centralized database; generating analytical insights data from analysis of the key data and historical data; displaying the analytical insights data onto a graphical user interface (GUI) for considering and analyzing the analytical insights data by a user; receiving user's feedback data that corresponds to the user's response based on analyzing the analytical insights data; and applying machine learning (ML) algorithms for continuously analyzing all available data as mentioned above including the user's feedback data and extracting and classifying contents of all available data including the feedback data to provide targeted recommendations data onto the GUI, but the disclosure is not limited thereto. The processor may be the same or similar to the processor 104 as illustrated in FIG. 1 or the processor embedded within DMD 202, DMD 302, DMM 306, DMD 402, and DMM 406.

According to exemplary embodiments, the instructions, when executed, may cause the processor 104 to generate structured and standardized dataset from the key data for analysis, wherein the structured and standardized dataset includes attributes derived from user input data including topic natural language processing.

According to exemplary embodiments, the instructions, when executed, may cause the processor 104 to generate the feedback data from the user's responses to pre-set questions, including selecting from pre-defined options and free-form text.

According to exemplary embodiments, the instructions, when executed, may cause the processor 104 to prioritize actions data from the targeted recommendations data that would yield the most value to an organization's predefined business goals.

According to exemplary embodiments, the instructions, when executed, may cause the processor 104 to implement text mining, natural language processing, and other ML techniques based on text input from the user.

According to exemplary embodiments, the instructions, when executed, may cause the processor 104 to extract data related to key themes and topics by store or branch segment, division, and market.

According to exemplary embodiments, the instructions, when executed, may cause the processor 104 to receive additional feedback data via the GUI that corresponds to the user's response based on analyzing the targeted recommendations data.

According to exemplary embodiments as disclosed above in FIGS. 1-7, technical improvements effected by the instant disclosure may include platforms for implementing a data management module for managing strategies and tactics of every store or branch in a network of stores or branches, along with a back end system that continuously learns from the data fed into the system, but the disclosure is not limited thereto.

According to exemplary embodiments as disclosed above in FIGS. 1-7, technical improvements effected by the instant disclosure may further include platforms for implementing a data management module that may provide at least the following improvements over conventional data management systems: it enables a two-way channel of communication between branch/store managers and analysts; it provides capability to capture and analyze feedback from the users that are consuming the analytical insights and targeted action recommendations, thereby strengthening the sense of being heard and fosters trust between front-line employees and back end analysts (via two-way channel of communication), and enabling the two groups to work together more effectively and to learn from the experience of the other; it enables continuous learning through the feedback loop of user-provided content and insights; implementing the ML layer in manner such that it is designed to update its understanding of relevant conditions, to make better recommendations over time; it provides a mechanism for institutional knowledge and experience to be retained when a user (branch manager or market director in this case) is no longer linked to the system (leaves the position or company). For example, an experienced manager may be familiar with particular management tactics that work well in certain situations. That content, when captured by the system of the instant disclosure, enables others—both present and future—to learn from this experience, but the disclosure is not limited thereto.

According to exemplary embodiments, the solution as disclosed herein with reference to FIGS. 1-7,

According to exemplary embodiments, the solution as disclosed herein with reference to FIGS. 1-7, could be leveraged for a wide array of purposes serving the needs of the business, including but not limited to controls documentation and enforcement, training content identification, branch/store employee time optimization, agility to respond to opportunities when changes to the competitive landscape occur, optimization of distribution network, optimization of branch/store format, optimization of branch/store staffing, optimization of branch/store hours of operation, etc.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for data management by utilizing one or more processors and one or more memories, the method comprising:
accessing a plurality of data sources that include internal data, third party data, user-generated content data, and historical data;
integrating the internal data, third party data, user-generated content data, and the historical data into key data that relates to management of one or more stores and branches in the network of stores and branches;
storing the key data into a single centralized database;
generating analytical insights data from analysis of the key data and historical data;
displaying the analytical insights data onto a graphical user interface (GUI) for considering and analyzing the analytical insights data by a user;
receiving user's feedback data that corresponds to the user's response based on analyzing the analytical insights data; and
applying machine learning (ML) algorithms for continuously analyzing all available data including the user's feedback data and extracting and classifying contents of all available data including the feedback data to provide targeted recommendations data onto the GUI.

2. The method according to claim 1, further comprising:
generating structured and standardized dataset from the key data for analysis, wherein the structured and standardized dataset includes attributes derived from user input data including natural language processing.

3. The method according to claim 1, wherein the feedback data is generated from the user's responses to pre-set questions, including selecting from pre-defined options and free-form text.

4. The method according to claim 1, wherein the targeted recommendations data includes customized recommendations data for every store or branch within the network of stores and branches, and personalized data based on full store-level or branch-level contextual data and segmentation.

5. The method according to claim 1, further comprising:
prioritizing actions data from the targeted recommendations data that would yield the most value to an organization's predefined business goals.

6. The method according to claim 1, further comprising:
implementing text mining, natural language processing, and other ML techniques based on text input from the user.

7. The method according to claim 1, further comprising:
extracting data related to key themes and topics by store or branch segment, division, and market.

8. The method according to claim 1, further comprising:
receiving additional feedback data via the GUI that corresponds to the user's response based on analyzing the targeted recommendations data.

9. The method according to claim 1, wherein the internal data, third party data, user-generated content data, and historical data relate to data relating to one or more stores and branches in a network of stores and branches including one or more of the following: data related to customers of a store or branch, data related to prospective customers of a store or branch, data related to nearby competitive stores or branch, and data related to macro-economic trends in the area.

10. A system for data management, the system comprising:
a plurality of data sources that include internal data, third party data, user-generated content data, and historical data; and
a processor coupled to the plurality of data sources via a communication network, wherein the processor is configured to:
integrate the internal data, third party data, user-generated content data, and the historical data into key data by accessing the plurality of data sources;
store the key data into a single centralized database;
generate analytical insights data from analysis of the key data and historical data;
display the analytical insights data onto a graphical user interface (GUI) for considering and analyzing the analytical insights data by a user;
receive user's feedback data that corresponds to the user's response based on analyzing the analytical insights data; and
apply machine learning (ML) algorithms for continuously analyzing all available data including the user's feedback data and extracting and classifying contents of all available data including the feedback data to provide targeted recommendations data onto the GUI.

11. The system according to claim 10, wherein the processor is further configured to:
generate structured and standardized dataset from the key data for analysis, wherein the structured and standardized dataset includes attributes derived from user input data including natural language processing.

12. The system according to claim 10, wherein the processor generates the feedback data from the user's responses to pre-set questions, including selecting from pre-defined options and free-form text.

13. The system according to claim 10, wherein the targeted recommendations data includes customized recommendations data for every store or branch within the network of stores and branches, and personalized data based on full store-level or branch-level contextual data and segmentation.

14. The system according to claim 10, wherein the processor is further configured to:
prioritize actions data from the targeted recommendations data that would yield the most value to an organization's predefined business goals.

15. The system according to claim 10, wherein the processor is further configured to:
implement text mining, natural language processing, and other ML techniques based on text input from the user.

16. The system according to claim 10, wherein the processor is further configured to:
extract data related to key themes and topics by store or branch segment, division, and market.

17. The system according to claim 10, wherein the processor is further configured to:
receive additional feedback data via the GUI that corresponds to the user's response based on analyzing the targeted recommendations data.

18. The system according to claim 10, wherein the internal data, third party data, user-generated content data, and historical data relate to data relating to one or more stores and branches in a network of stores and branches including one or more of the following: data related to customers of a store or branch, data related to prospective customers of a store or branch, data related to nearby competitive stores or branch, and data related to macro-economic trends in the area.

19. A non-transitory computer readable medium configured to store instructions for data management, wherein, when executed, the instructions cause a processor to perform the following:
accessing a plurality of data sources that include internal data, third party data, user-generated content data, and historical data;
integrating the internal data, third party data, user-generated content data, and the historical data into key data that relates to management of one or more stores and branches in the network of stores and branches;
storing the key data into a single centralized database;
generating analytical insights data from analysis of the key data and historical data;
displaying the analytical insights data onto a graphical user interface (GUI) for considering and analyzing the analytical insights data by a user;
receiving user's feedback data that corresponds to the user's response based on analyzing the analytical insights data; and
applying machine learning (ML) algorithms for continuously analyzing all available data including the user's feedback data and extracting and classifying contents of all available data including the feedback data to provide targeted recommendations data onto the GUI.

20. The non-transitory computer readable medium according to claim 19, wherein, when executed, the instructions further cause the processor to perform the following:
generate structured and standardized dataset from the key data for analysis, wherein the structured and standardized dataset includes attributes derived from user input data including natural language processing.
